(19) United States
(12) Patent Application Publication
(10) Pub. No.: US 2014/0031967 A1
(43) Pub. Date: Jan. 30, 2014

(54) METHOD AND SYSTEM FOR RAPID PROTOTYPING OF COMPLEX STRUCTURES

(71) Applicant: 6598057 Manitoba Ltd., Winnipeg (CA)

(72) Inventors: Bertram John Unger, Winnipeg (CA); Jordan Brent Hochman, Winnipeg (CA); Jay Kraut, Winnipeg (CA)

(73) Assignee: 6598057 Manitoba Ltd., Winnipeg (CA)

(21) Appl. No.: 13/935,681

(22) Filed: Jul. 5, 2013

Related U.S. Application Data
(60) Provisional application No. 61/677,125, filed on Jul. 30, 2012.

(51) Int. Cl. B29C 67/00

(52) U.S. Cl. CPC B29C 67/0088
USPC 700/119

(57) ABSTRACT

A method is provided for rapid prototyping of complex structures, such as complex bone structures and internal neural and cardiovascular pathways. The method involves loading the triangles from a polygonal mesh computer model of a 3D object having one or more internal void spaces, converting the triangles to voxels, separating the voxels of the model into watertight pieces, and printing the pieces using a 3D printer such as a ZPrinter™. The method allows realistic internal void space representation through removal of excess powder from printing which would otherwise be trapped in the whole object and also allows the application of a resin to internal surfaces which may provide realistic internal object density useful for medical and other applications. Pegs and holes may also be added to and subtracted from the pieces to allow for assembly of the printed object. A system and computer program product is also provided.

### FIELD OF THE APPLICATION

The present application relates to a method and system for rapid prototyping complex structures, and more particularly, a method and system for rapid prototyping of complex structures from a high-resolution three-dimensional (3D) model of a 3D object having one or more internal void spaces where the prototype may also be provided with homogenous and realistic object density both externally and internally.

### BACKGROUND OF THE APPLICATION

Rapid prototyping may be used to generate a physical model from 3D digital data. Initially, rapid prototyping was used to quickly generate industrial models for evaluation prior to large scale manufacture. The process involved complex milling operations and costs were high. The development of stereolithography and 3D printing have furthered this line of technology by providing additional precision and reduced cost.

One process for rapid prototyping initially developed at the Massachusetts Institute of Technology known as ZPrinting and found in printers sold by Z Corporation (now 3D Systems™) referred to as ZPrinters™ may employ a powder bed and inkjet-like printing head. The part to be printed is built up from many thin cross-sections of the 3D digital model. The inkjet-like printing head moves across a bed of powder and selectively deposits a liquid binding material in the shape of the object to be printed. A fresh layer of powder is spread across the top of the model and the process is repeated until printing is complete. Any unbound powder may be removed, but to the extent that the object has internal void spaces, excess powder may be trapped therein. Successive cross-sectional layers may build up a physical 3D model of almost any geometric shape in which the model to be printed is watertight. This technique is relatively inexpensive and rapid.

Rapid prototyping has been used in the medical field for education and operative preplanning. But, to date, only surface or external validity has been possible. As discussed above, internal air-filled spaces may be full of residual powdered printing material used in the printing process and therefore object density may not be realistic as only the exterior of the printed object may be exposed to the binding resin that may generate the density needed to make the printed object of the same or similar density as the real object after which the printed object is modeled.

Accordingly, there remains a need for improvements in the art.

### BRIEF SUMMARY OF THE INVENTION

Embodiments of the present invention may allow a whole object to be printed to be separated into pieces using a computer program so that powder used during the printing process that would otherwise be trapped internally if the whole object were printed may be removed, and resin used for density may be applied to both internal and external surfaces as opposed to only external surfaces and thereby better achieve a density which is the same or similar to the real object that the printed object is modeled after. The data generated by the computer program is used to print pieces of the model in which internal void spaces may be exposed. Prior to assembling the pieces of the model into a whole object, the desired hardening resin may be applied. According to some embodiments of the invention, the computer program may also facilitate user-directed placement of fidicual markers to generate pegs and holes in the pieces that aid in assembly of the printed object.

According to one aspect, the present invention provides a method of making a three-dimensional (3D) object in pieces from a high-resolution model of a 3D object having one or more internal void spaces. According to another aspect, the present invention provides a 3D object made according to the claimed methods. According to another aspect, the present invention provides a system for making a three-dimensional (3D) object in pieces from a high-resolution model of a 3D object having one or more internal void spaces. According to another aspect, the present invention provides a computer program product for generating data in a format suitable for a 3D printer to print the pieces of the 3D object to be made according to the method.

According to one embodiment, the present invention provides a method of making a three-dimensional (3D) object from a high-resolution model of a 3D object having one or more internal void spaces, the method comprising: providing a high-resolution model of a 3D object in a computer-readable format, the 3D object having one or more internal void spaces, the model comprising a polygonal mesh including a plurality of triangles; converting the triangles to voxels; separating the voxels such that the model is separated into watertight pieces; and printing the pieces using a 3D printer.

According to another embodiment, the present invention provides a 3D object made according to the method above.

According to another embodiment, the present invention provides a system comprising for making a three-dimensional (3D) object from a high-resolution model of a 3D object having one or more internal void spaces, the system comprising: a computer network; a computer connected to the computer network, the computer including one or more non-transient computer memories storing a high-resolution model of a 3D object in a computer-readable format, the 3D object having one or more internal void spaces, the model comprising a polygonal mesh including a plurality of triangles, and computer-readable instructions, which when executed, are for: converting the triangles to voxels; separating the voxels such that the model is separated into watertight pieces; wherein the computer is configured to send computer-readable data representing the pieces over the computer network; and a 3D printer connected to the computer network and configured to receive computer-readable data representing the pieces over the computer network and to print the pieces in physical form.

According to another embodiment, the present invention provides a computer program product for use in making a three-dimensional (3D) object from a high-resolution model of a 3D object having one or more internal void spaces, the computer program product comprising: a tangible storage medium storing computer-readable instructions; the computer-readable instructions including instructions for: receiving a high-resolution model of a 3D object in a computer-readable format, the 3D object having one or more internal void spaces, the model comprising a polygonal mesh including a plurality of triangles; converting the triangles to voxels; separating the voxels such that the model is separated into watertight pieces; and exporting the voxels in a format suitable for a 3D printer to print the pieces.

Other aspects and features according to the present application will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawing which shows, by way of example, embodiments of the invention, and how they may be carried into effect, and in which:

FIG. 1 is a flow chart of a method according to an embodiment of the present invention;

FIG. 2 is a flow chart of a further method according to an embodiment of the present invention;

FIG. 3 is an architecture diagram of a system according to an embodiment of the present invention;

FIG. 4 shows a lateral skull-base with internal anatomy and slicing according to an embodiment of the present invention;

FIG. 5A shows slicing with user directed sectioning of sheep femur and FIG. 5B shows the associated cross-section of the sheep femur according to an embodiment of the present invention;

FIG. 6A shows a lateral perspective of a temporal bone with delineated piece for slicing according an embodiment of the present invention;

FIG. 6B shows multi-plane slicing according to an embodiment of the present invention;

FIG. 6C shows a transparent view through a specimen with appreciation of internal constructs according to an embodiment of the present invention;

FIG. 7A shows holes added to the model for receiving pegs (shown in FIG. 7B) to permit reassembly of the printed object according to an embodiment of the present invention;

FIG. 7B shows pegs added to the model for inserting into holes (shown in FIG. 7A) to permit reassembly of the printed object according to an embodiment of the present invention;

FIGS. 8A and 8C-8F show graphs and FIG. 8B shows a table of the results of a study assessing resin applied to printed objects according to the present invention;

FIGS. 9A and 9B show slicing of a model of vertebrae and FIGS. 9C and 9D show the resultant printed object, wherein FIG. 9C shows how void spaces may be represented in the printed object, according to an embodiment of the present invention;

FIGS. 10A and 10B show slicing of a model of a femur and FIG. 10C shows the resultant printed piece according to an embodiment of the invention;

FIG. 11 shows a side-by-side comparison of an original bone air-cell system model and the resultant printed facsimile object air cell system according to an embodiment of the present invention in which void spaces are nearly-identically represented; and

FIGS. 12A-D show the results of a validation study of a rapid prototype temporal bone according to an embodiment of the present invention. FIG. 12A shows the overall appreciation evaluation, FIG. 12B shows the evaluation of the physical representation of bone, FIG. 12C shows the evaluation of visual representation of internal constructs, and FIG. 12D shows the evaluation of utility in training surgical procedures.

Like reference numerals indicate like or corresponding elements in the drawings.

### DETAILED DESCRIPTION OF THE EMBODIMENTS

Embodiments of the present invention are generally directed to a method and system for rapid prototyping complex structures, and more particularly, a method and system for rapid prototyping of complex structures in pieces from a high-resolution three-dimensional (3D) model of a 3D object having one or more internal void spaces. Embodiments of the invention may allow the internal structure of an object to be more accurately depicted visually and possess the desired density.

According to an embodiment, a computer program is provided in which a whole object may be separated into pieces by slicing through selected planes so that internal void spaces may be exposed and excess internal materials, such as powder or dust arising during manufacture, may be removed and resin applied for density may access the entire structure and not simply the surface. The computer program may produce data that may be used to drive a ZPrinter® 3D printer or similar 3D printer to make pieces of the model in a manner which may expose the internal void spaces.

Pre-existing computer graphics programs such as ZEdit, 3D Studio Max, and Mimics either fail to provide functionality to readily split high-resolution models into watertight pieces or use a computationally-intensive processing algorithm such as Constructive Solid Geometry (CSG) that cannot process the volume of data used in high-resolution models, such as those used for medical applications, in a timely manner.

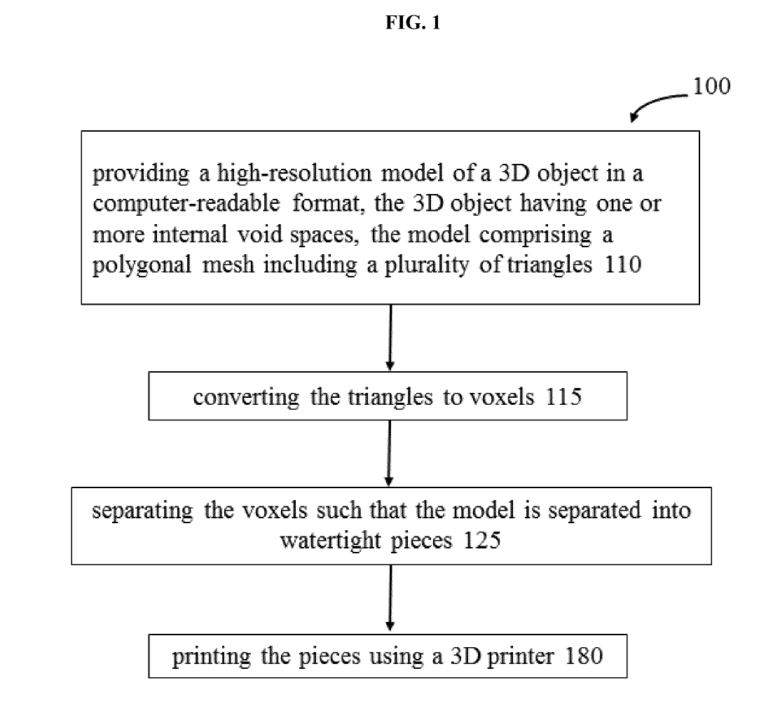

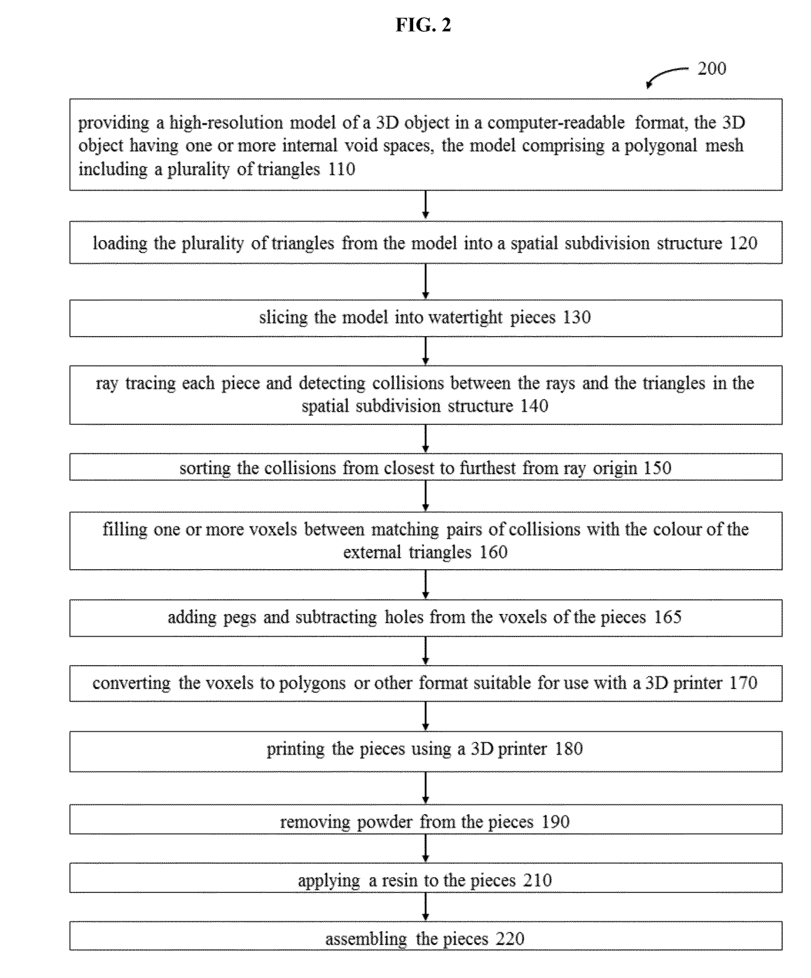

According to an embodiment as shown in FIG. 1, a method 100 starts with providing a high-resolution model of a 3D object in a computer-readable format in step 110. The model may comprise a polygonal mesh including a plurality of triangles. Moreover, the 3D object may have one or more internal void spaces. Thereafter, in step 115, the triangles may be converted to voxels. Thereafter, in step 125, the voxels may be separated, for example by slicing, such that the model is separated into watertight pieces. Lastly, in step 180 the pieces may be printed using a 3D printer. Additional details pertaining to the preceding steps are discussed in more detail further below.

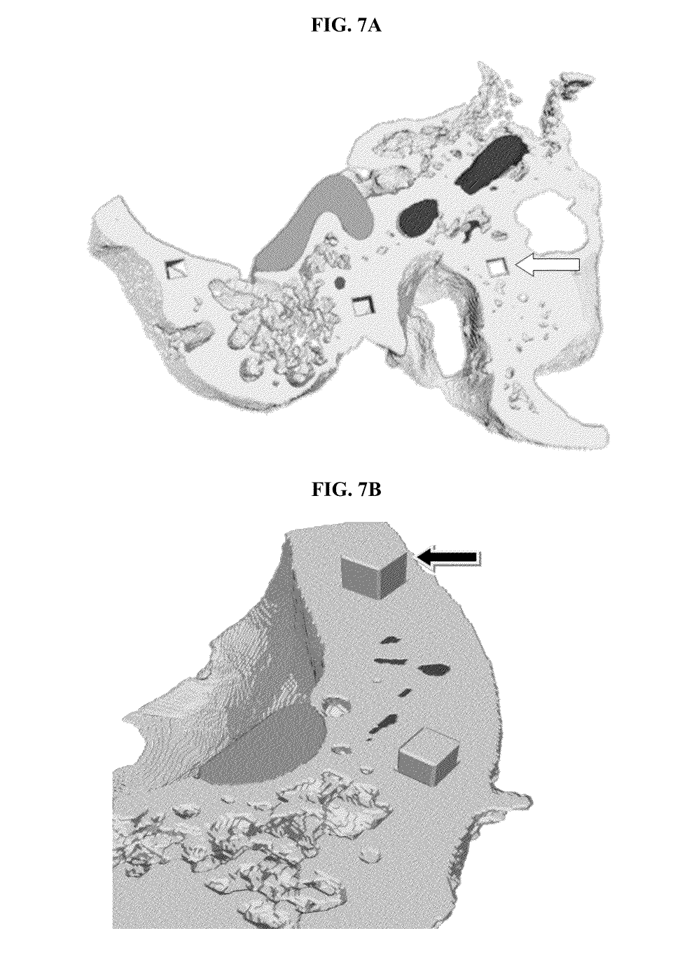

According to an embodiment as shown in FIG. 2, a method 200 starts with providing a high-resolution model of a 3D object in a computer-readable format in step 110. The model may comprise a polygonal mesh including a plurality of triangles. Moreover, the 3D object may have one or more internal void spaces. Thereafter, in step 120, the plurality of triangles from the model is loaded into a spatial subdivision structure such as an octree. The model may then be sliced into watertight pieces in step 130. Ray tracing is then carried out for each piece and collisions are detected between the rays and the triangles in the spatial subdivision structure in step 140. The collisions may then be sorted from closest to furthest from ray origin in step 150. Thereafter, in step 160, the voxels between matching pairs of collisions (discussed below) are filled with the colour of the external triangle. The user may also add pegs and subtract holes from the voxels of the pieces in step 165 which will create physical pegs and holes in the printed object, as shown in FIGS. 7A and 7B, which may aid in assembly of the pieces of the object in step 220. If needed for printing, the voxels may be converted to polygons or another format suitable for use with a 3D printer in step 170, and the pieces may be printed using a 3D printer, such as a ZPrinter™, in step 180.

According to an embodiment, interlocking fiducial markers may be placed on each piece in user-selected locations, using the computer program. According to an embodiment, the user of the computer program may place the fiducial markers on the computer model where pegs are to be added to computer model. According to an embodiment, the user of the computer program may place fiducial markers on the computer model where holes are to be subtracted from computer model. According to a further embodiment, the computer program may generate and place a corresponding hole or peg once the user places a hole or peg on the computer model. According to a further embodiment, the computer model may adjust the user's placement of fiducial marker to the nearest suitable location should the user's placement not allow for printing of watertight pieces.

According to some embodiments, once the computer model has been printed in pieces, powder or dust may be removed from each piece in step 190 using compressed air. A hardening infiltrant, such as a resin, may then be applied to each individual piece in step 210. For example, each individual piece may be soaked in resin. The individual pieces may then be dried or left to dry. As discussed above, resin used for density can be applied to both internal and external surfaces as opposed to only external surfaces and thereby better achieve a density which is the same or similar to the real object which the printed object is modeled after.

Once dry, the individual pieces may be press-fit assembled using the peg and hole fiducials described above. After assembling the pieces into a model of the whole object, the whole structure may again be exposed to the infiltrant in order to bind the pieces together such that the complete model may be a realistic replica of the original with internal structures and void spaces accurately reproduced.

According to an embodiment, suitable powders for manufacture of the object using a 3D printer may include any powder capable of being removed using gravity or compressed air. Examples of suitable powders may include plaster, rubber, ABS plastics, glass beads, titanium, steel, polymers, nylon, polystyrene, green sand, and alloys. According to an embodiment, the powder may be Zp™ 150 (3D Systems™) (high performance composite material).

According to an embodiment, suitable resins may include any resin capable of penetrating a piece to at least half of the minimum slice thickness. Examples of suitable resins may include wax, Epsom salts, cyanoacrylate, and epoxy resins. In the examples according to embodiments of the invention discussed below, X-TRA™ wax, Epsom salts, Z-Bond™ 90 and Z-Bond™ 101 (both cyanoacrylate resins) and Z-Max™ 90 (an epoxy resin) have been used.

3D printers may require that a model to be printed be watertight, that is, divisible into an outside and an inside surface with no connection between the two. A computer model may be represented by triangles, where each triangle contains a surface normal, that is, a vector that is perpendicular to the surface. The vector either points out of the triangle or into the triangle. According to an embodiment, watertight may refer to that fact that the computer model has a bounding shell that is completely sealed with triangles with normals pointing outwards from the shell.

According to an embodiment, one method to convert triangles to volume units may involve subdividing a computer model into layers, where each layer may be referred to as being in z-space. Given a layer that is one voxel high, for each row in that layer, which may be referred to as being in x-space, which is one voxel wide, a ray may be cast. This ray may traverse the row and is sampled for each voxel column which may be referred to as being in y-space. Accordingly, in a model, every voxel (x,y,z) may be sampled to determine if it is full or empty.

Each time the ray passes between empty and occupied space there should be one triangle collision. The list of triangles that collide with the ray are sorted from closest to furthest from ray origin because the order of a collision in an octree cell is unsorted. The sorted list may contain pairs of triangles, the first triangle of a pair has its triangle pointing in opposite direction to the ray, and the second triangle of a pair has its normal pointing in the same direction as the ray. Space between the two triangles may therefore consists of voxels that are set to being filled. If the space is not water tight, for example there is a collision with triangle that does not have a matching pair, it is unclear if that area should be filled in or left empty. According to an embodiment, non-matching triangles are ignored and the area is left empty.

Similarly, embodiments of the present invention may employ back-face culling when displaying computer models to the user. Back-face culling is a computer graphics principle which determines whether a polygon is visible, i.e. the computer program only needs to draw front facing triangles. In back-face culling, triangles that are back facing do not need to be drawn since the viewer may not see them through the front facing triangles. The front or back facing determination is done by comparing the normal of the triangle to the camera direction.

According to an embodiment, the conversion of anatomy from an imaging modality to a 3D file may be done using a separate computer program, such as third party commercial software Mimics™ or Amira™. According to a further embodiment, functionality for converting from an imaging modality to a 3D file may be integrated into the same computer program as the present invention. According to an embodiment, such software may threshold each pixel of each CT scan or other image slice. If the value of the pixel in the Hounsfield scale is inside of the thresholding values it may be specified as belonging to a segmentation layer. A region-based image segmentation method such as region growing may then be used to only select bone that is attached to a starting location (i.e. to get rid of stray bone that is probably noise). Then these selected voxels may used to make a 3D model. While the process of segmenting bone is relatively straightforward, soft tissue segmentation may be more difficult. A lower threshold, dynamic region growing, other techniques as well as manual work may be required to segment soft tissue since there may be less of an exact range in the Housfield scale for soft tissue. Segmented data may then be imported into the computer program of the present invention for slicing.

According to an embodiment, a computer program is provided which may receive a primary polygonal mesh computer model which may be combined with any number of secondary models (including zero). According to an embodiment, secondary models may represent, for example, arteries, veins, nerves, or any other feature that needs to be coloured or denoted differently or requires a different density. According to an embodiment, secondary models are provided by the segmented data discussed above.

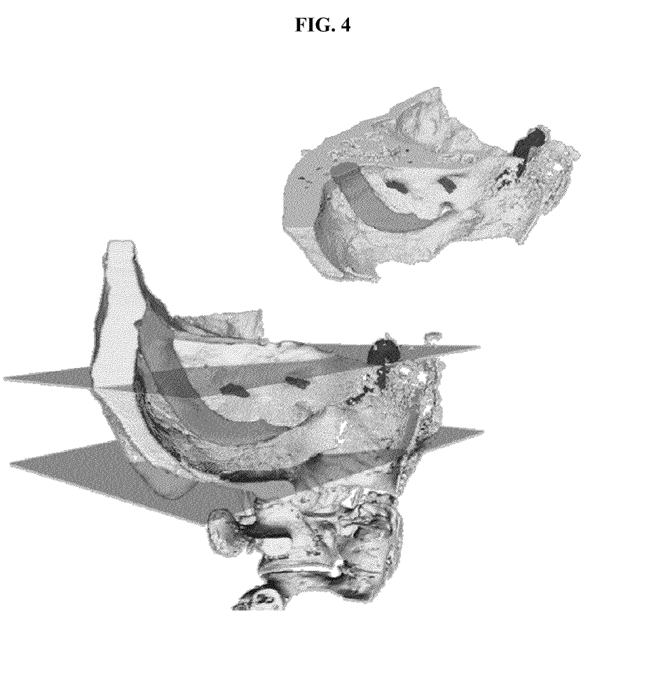

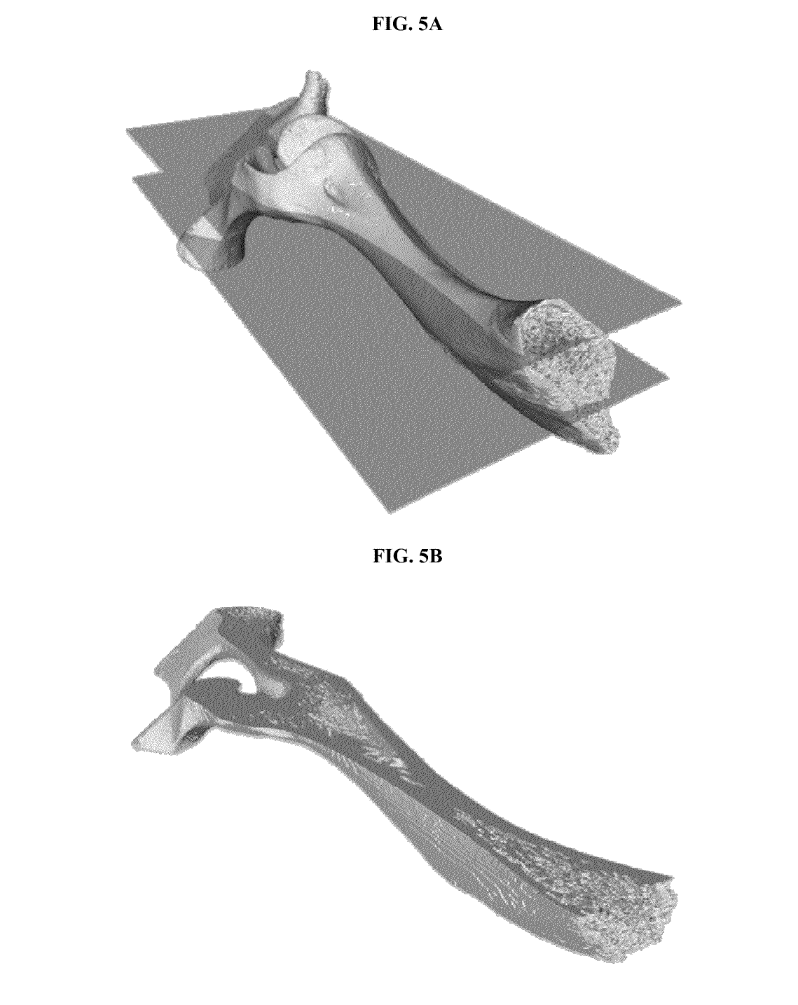

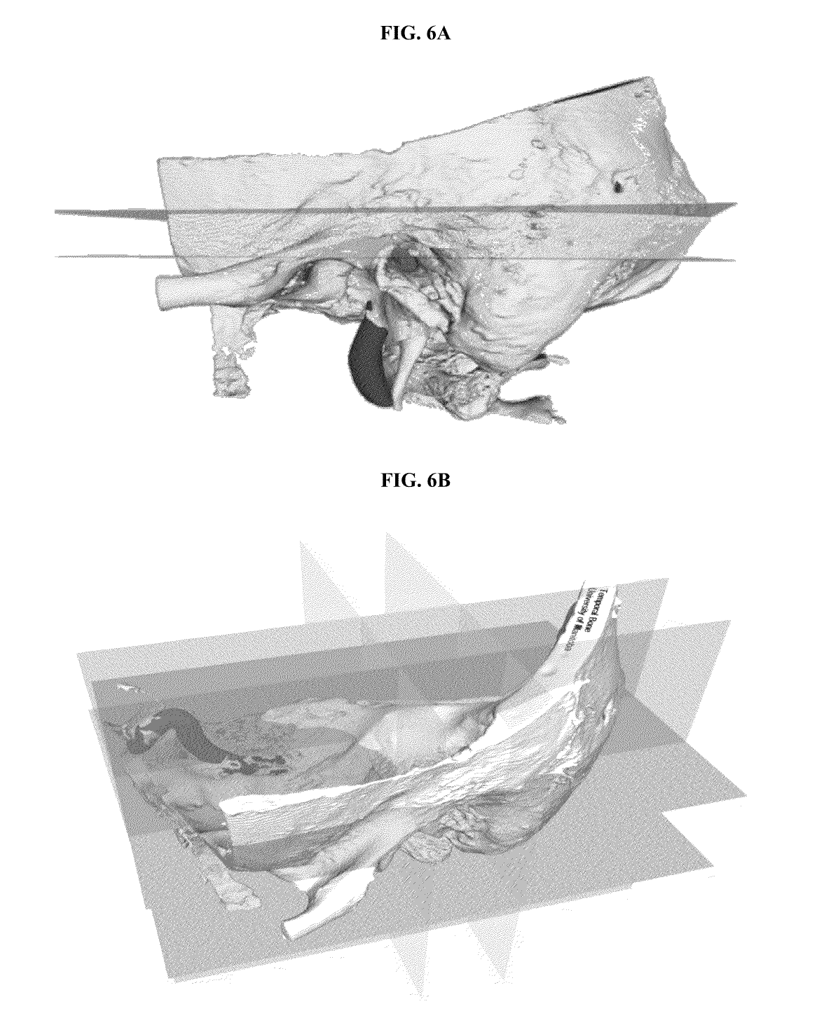

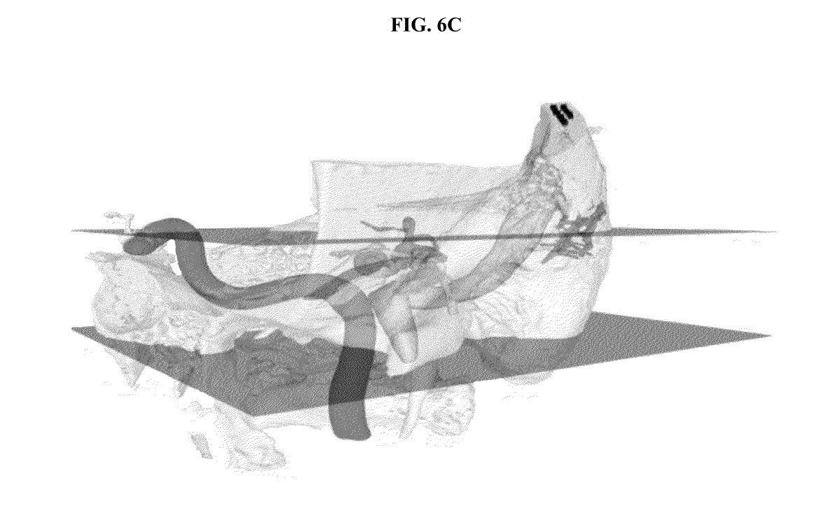

According to an embodiment, the computer model from which the rapid prototype will be manufactured may be divided or sliced into watertight pieces. FIGS. 4-6 show the slicing of various models according to embodiments of the present invention. According to an embodiment, the division of the model into pieces may also allow even hardening and curing of the model, if desired. The non-integral material within the void spaces may be loose powder in 3D printing and laser scintering processes or liquid in stereolithography processes. The location and orientation of the pieces may be defined by the computer program which may permit a user to manipulate the orientation of the model and select divisions of the model such that internal void spaces may be cleared of these loose materials.

The triangles from the primary model are loaded into memory and into a spatial subdivision structure that speeds up collision detecting by eliminating sections as not of interest for the later ray casting. According to an embodiment, the spatial subdivision structure may be an octree. Although binary space partitioning (BSP) trees may allow spatial information to be accessed rapidly, for high-resolution models such as those used to create realistic anatomy for medical applications, an octree is much quicker to construct than a binary space partitioning (BSP) tree which is often used when spatial information needs to be accessed rapidly. The octree may be constructed using the bounding box dimensions (i.e. the coordinates of the closed volume that fully encloses the digital model) of the primary model.

The triangles from any secondary models, potentially coloured differently, may then loaded into further spatial subdivision structures such as octrees (one octree per secondary model) and placed in the same rendering buffer as the octree for the primary model.

The user of the computer program then specifies how the model is to be divided into pieces, after which, ray tracing is performed for each piece and collisions between rays and triangles may be determined for the primary and secondary models. Collisions may then be sorted from closest to furthest from the ray origin. Matching pairs of collisions, as described above, indicate a volume. For each pair, any voxels between them are filled in and given the color of the external triangles. According to an embodiment, in areas that contain both colored and white (bone) voxels the colour voxels may be given precedent. This may be performed by processing the primary model first and then processing any secondary models such that the later applied voxels may overwrite the previously-filled in voxels, to the extent that any overlapping voxels are present.

According to an embodiment, pegs may then be added and holes may then be subtracted from the voxels that make up the individual pieces in user-defined locations.

According to an embodiment, the user may also select a feature to be hollowed out. If the user does so, an algorithm may determine the distance of a voxel to the outer surface of the model. According to an embodiment, voxels with a distance higher than a preset user setting may be removed, thus hollowing out the feature. According to an embodiment, after the object has been printed, material may then be injected into these hollow voids to simulate soft tissue.

Moreover, additional void spaces may be created to generate a series of channels to facilitate the removal of dust or other print material within each piece. This may permit the powder that is used in printing to be removed and also may expose the internal structure to resin, which may increase density. According to a further embodiment, a specimen may be augmented and segment size modified through digital generation of a series of connected pathways that both permit the removal of excess powder and exposure to resin. These steps may be applied in parallel or in isolation.

According to an embodiment, the voxels may be stored in memory and then converted back into polygons or other suitable format for a 3D printer prior to printing. According to an embodiment, a marching cubes algorithm may be used to convert the voxels back into polygons. The marching cubes algorithm may be run several times; once for the primary model (e.g. the overarching bone structure) and once for each secondary model (e.g. colored structure of interest). This may be done so that even if the structures overlap they still get a watertight shell. Then the polygons may be exported for printing.

According to an embodiment, steps of the methods discussed above may be multithreaded to improve the performance.

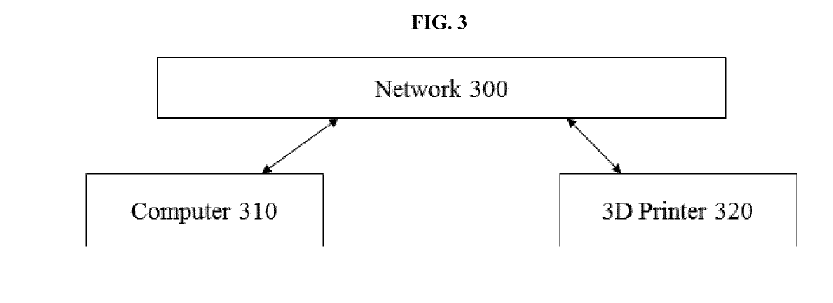

According to an embodiment of a system according to the present invention as shown in FIG. 3, a system for executing the methods of the invention may be provided where a computer 310 and 3D printer 320, such as a ZPrinter™, are connected to a computer network 300 which itself may be one or more computer networks. The computer 310 includes a one or more non-transitory computer memories storing a high-resolution model of a 3D object in a computer-readable format, where the model comprises a polygonal mesh including a plurality of triangles. The 3D object may have one or more void spaces. The computer also stores computer-readable instructions, which when executed, are for receiving a high-resolution model of a 3D object in a computer-readable format, the model comprising a polygonal mesh including a plurality of triangles, converting the triangles to voxels; separating the voxels such that the model is separated into watertight pieces, and exporting the voxels in a format suitable for a 3D printer to print the pieces. Alternatively, the computer-readable instructions may be for loading the plurality of triangles from the model into a spatial subdivision structure, slicing the model into watertight pieces, ray tracing each piece and detecting collisions between the rays and the triangles in the spatial subdivision structure, sorting the collisions from closest to furthest from ray origin, filling the voxels between matching pairs of collisions with the colour of the external triangles, and converting the voxels to polygons or other suitable format for use with a 3D printer. Computer-readable instructions for other method steps discussed herein may also be included. The computer 310 may also be configured to send computer-readable data representing the pieces over the computer network to the 3D powder printer 320. The 3D printer 320 may be connected to the computer network and may be configured to receive computer-readable data representing the pieces over the computer network 300 and to print the pieces in physical form.

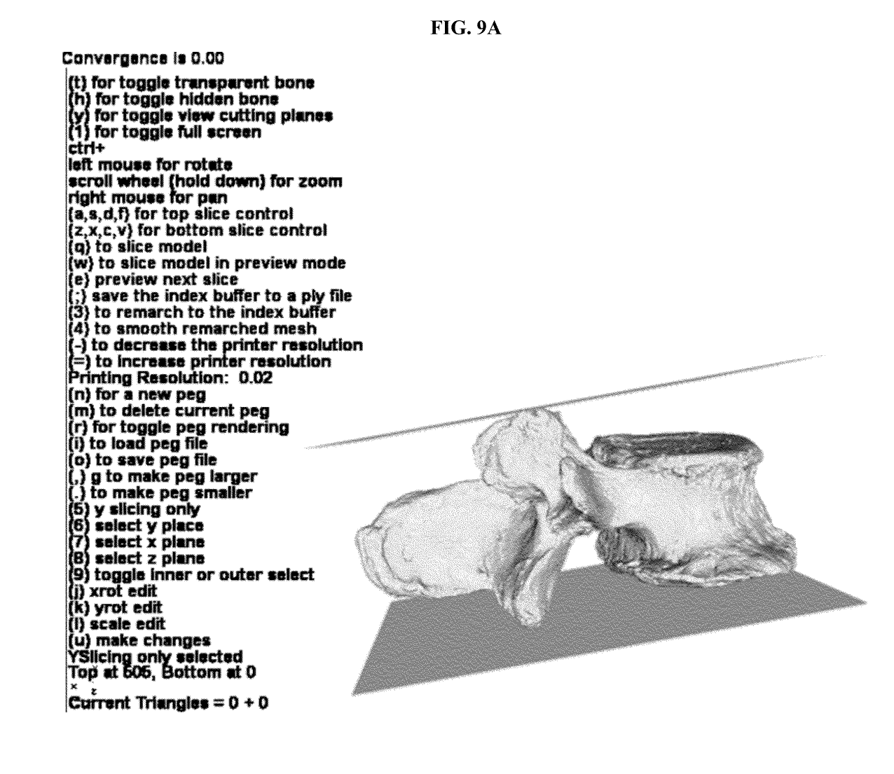

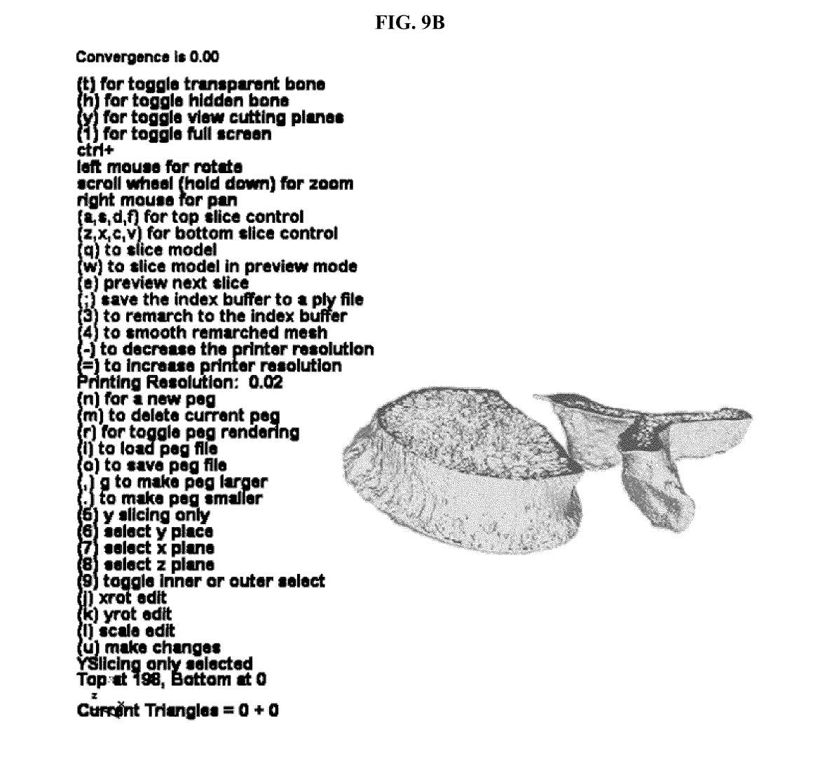

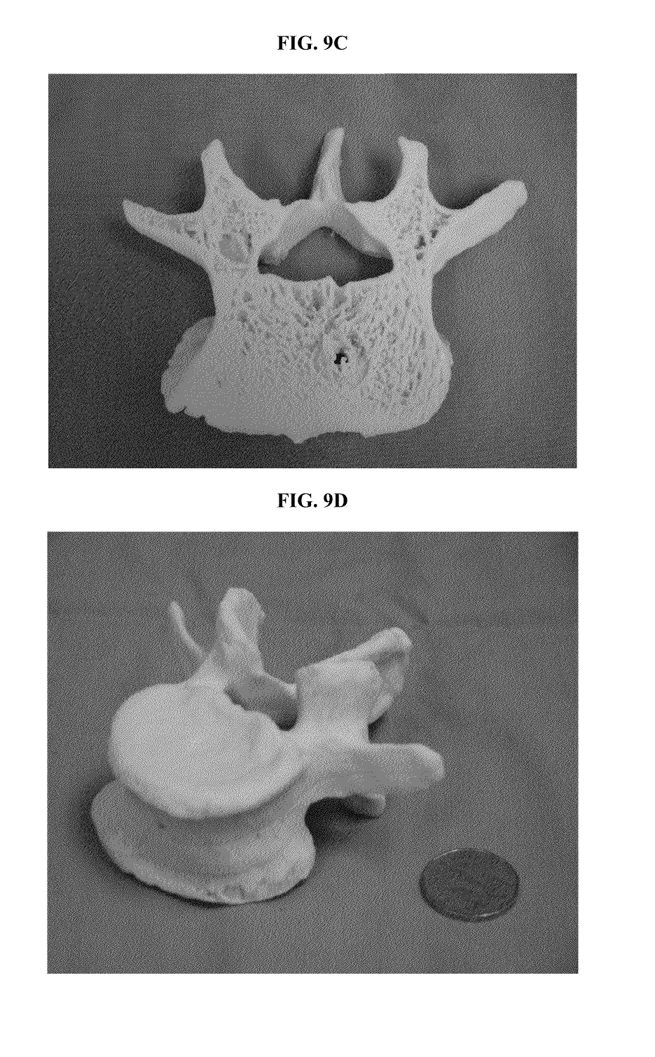

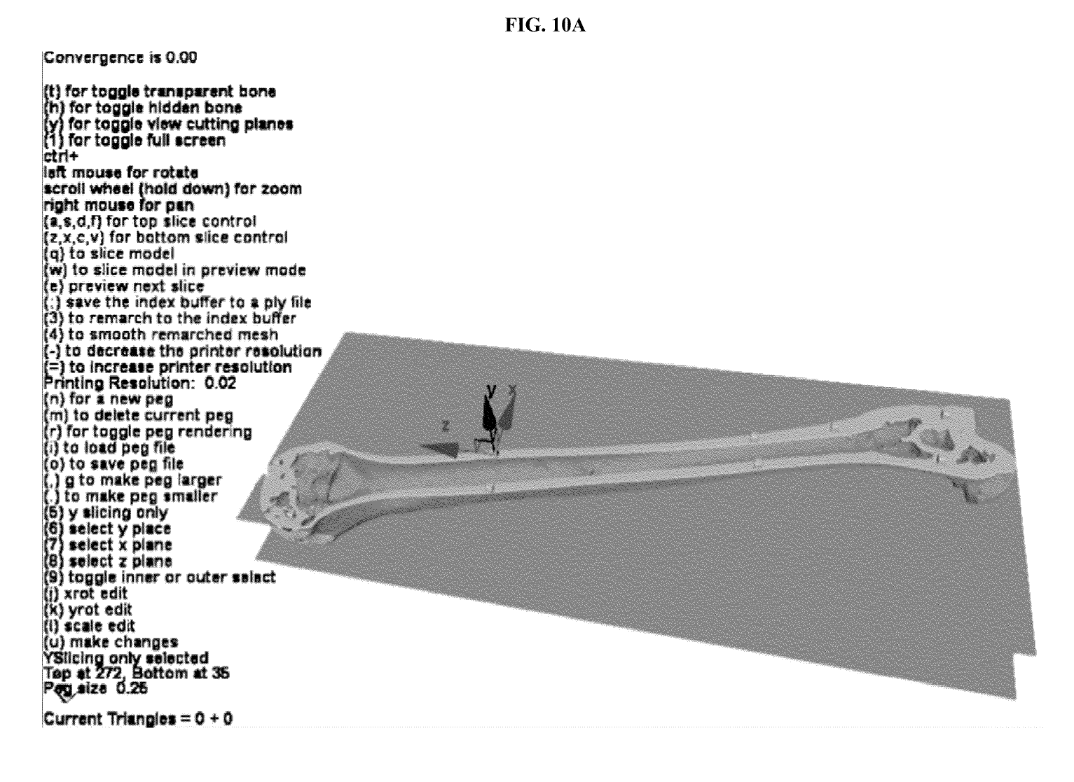

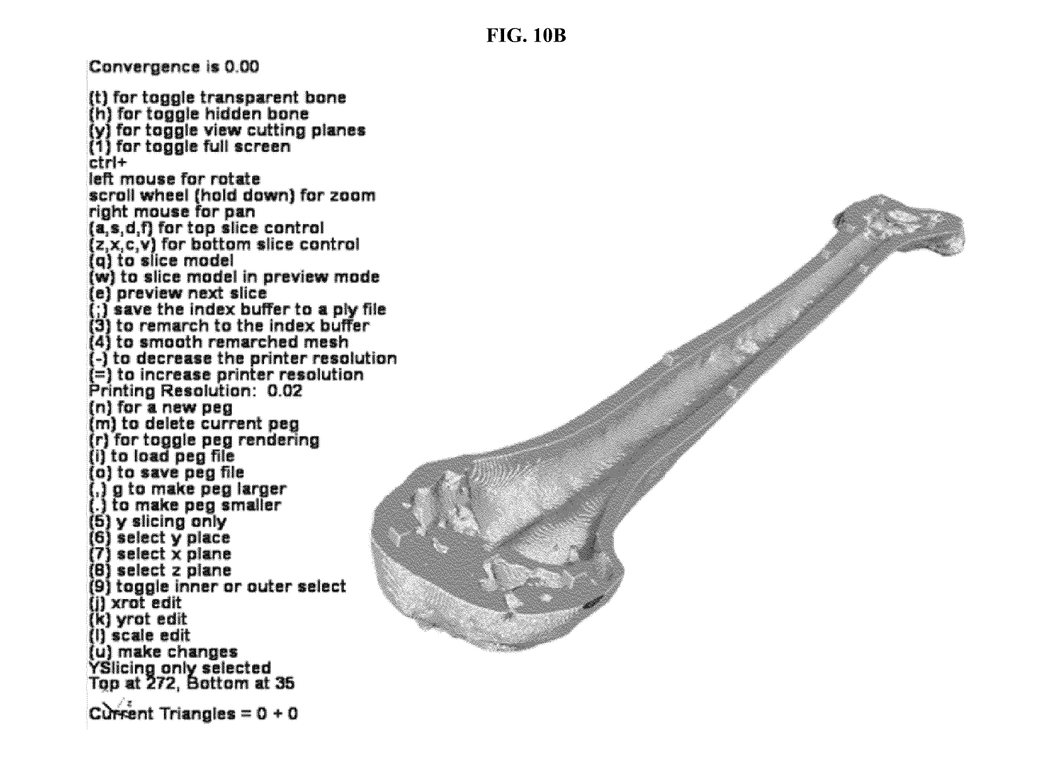

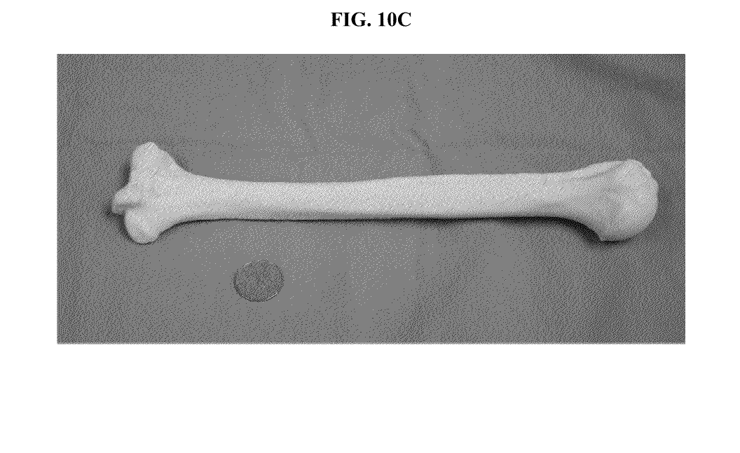

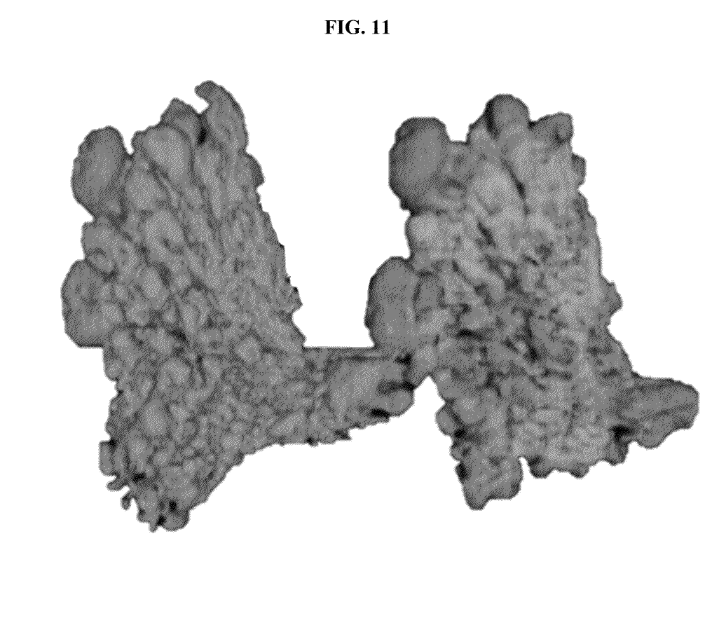

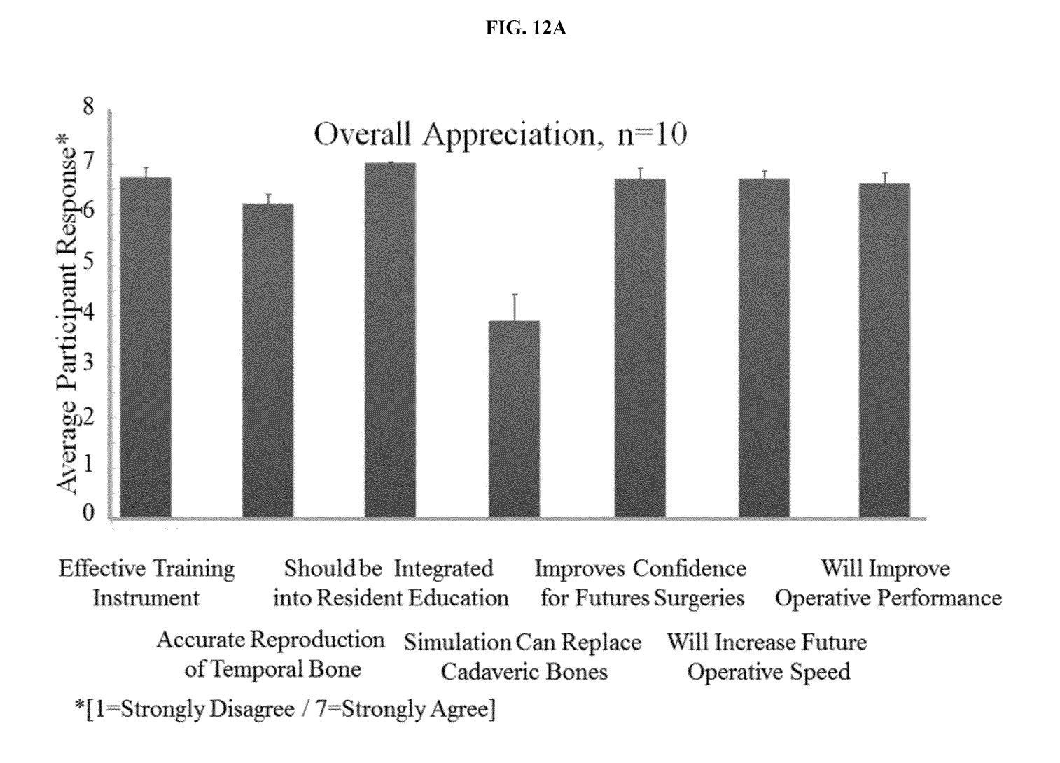

According to an embodiment, the present invention may be used to accurately recreate bone density that is the same or similar to that of the real object. This may allow surgeons and trainees to experience real-to-life interaction with surgical tools. According to an embodiment, the method may be used to recreate bone structures of varying complexity such as spinal bone structures, temporal bones, skull bones, and long bones. FIGS. 9-11 show examples of slicing and the resultant printed objects according to embodiments of the present invention for a model of vertebrae, a model of a femur and a model of a bone air-cell system. According to some embodiments, the method may also be used to recreate non-medical objects in which uniform density and preservation of internal spaces may be desired, for example, microfluidic channels or closed gear boxes.

Potential uses of embodiments of the present invention in the medical field may include producing a library of models of bones that could be drilled for general practice, producing a model, for example, of a spine, skull, a long bone, paranasal sinuses or a temporal bone, that may be dissected as part of a rehearsal or practice surgery to identify or appreciate potential areas of possible morbidity, or producing models for patient education, that is, to explain procedures and potential problems to a patient. Such models may also be used for novel technique exploration, for example, robotic cochlear lead insertion.

After the present invention was developed, a study was undertaken to determine the appropriate resin to employ in the creation of an accurate facsimile of bone. A sheep femur was employed for comparative purposes and the specimen was generated and segmented after CT Digital Imaging and Communications in Medicine (DICOM) data was obtained. The specimen was digitally divided into segments with fiducials for assembly. The model was printed using a 3D Systems™ 650 Z Corp™ machine and all printing material was then removed from the void spaces. The study included 11 participants with varying experience using an otic burr to drill bone. Both cortical and trabecular bone were analyzed independently.

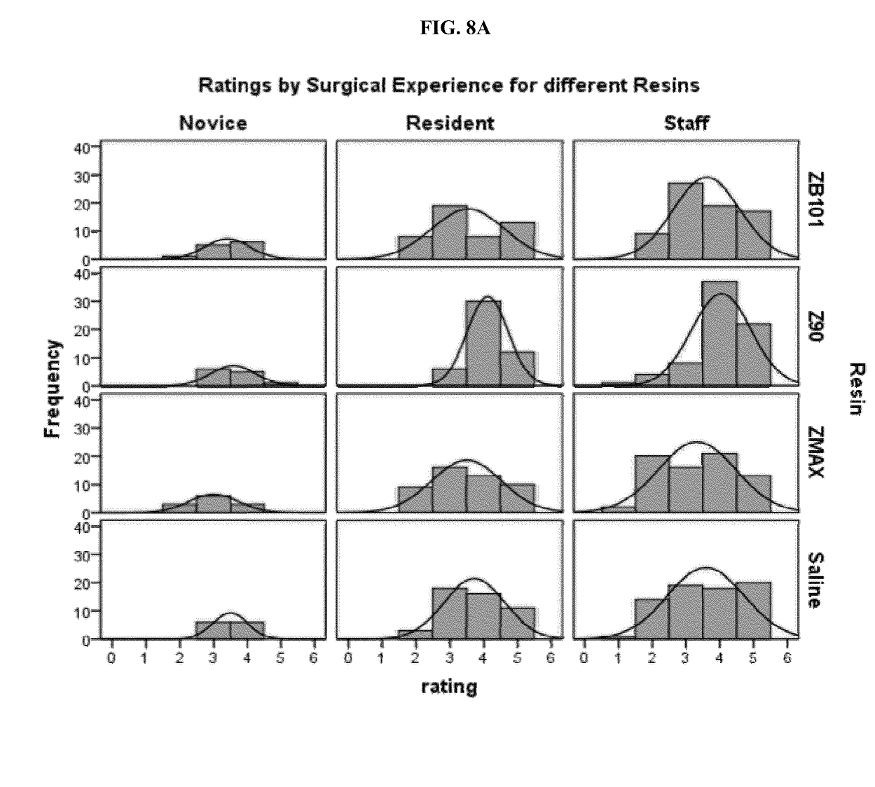

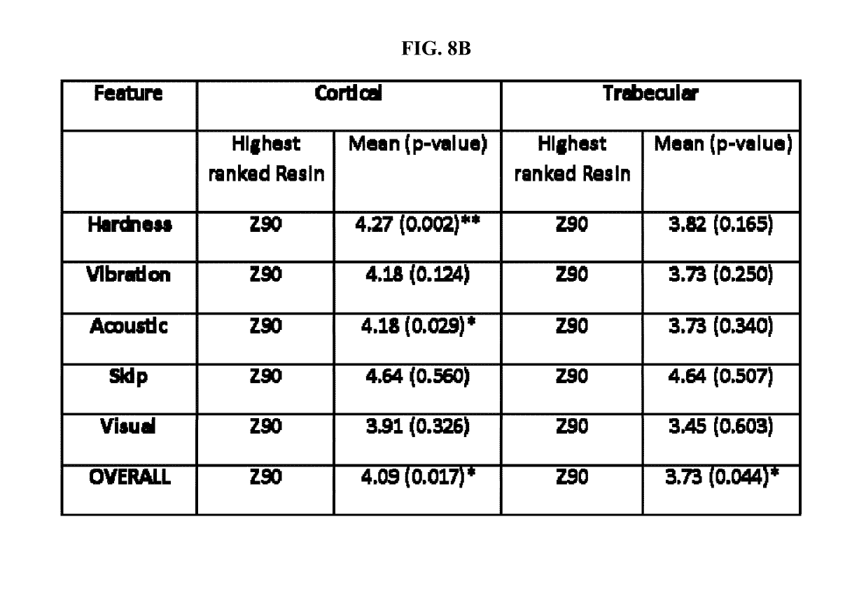

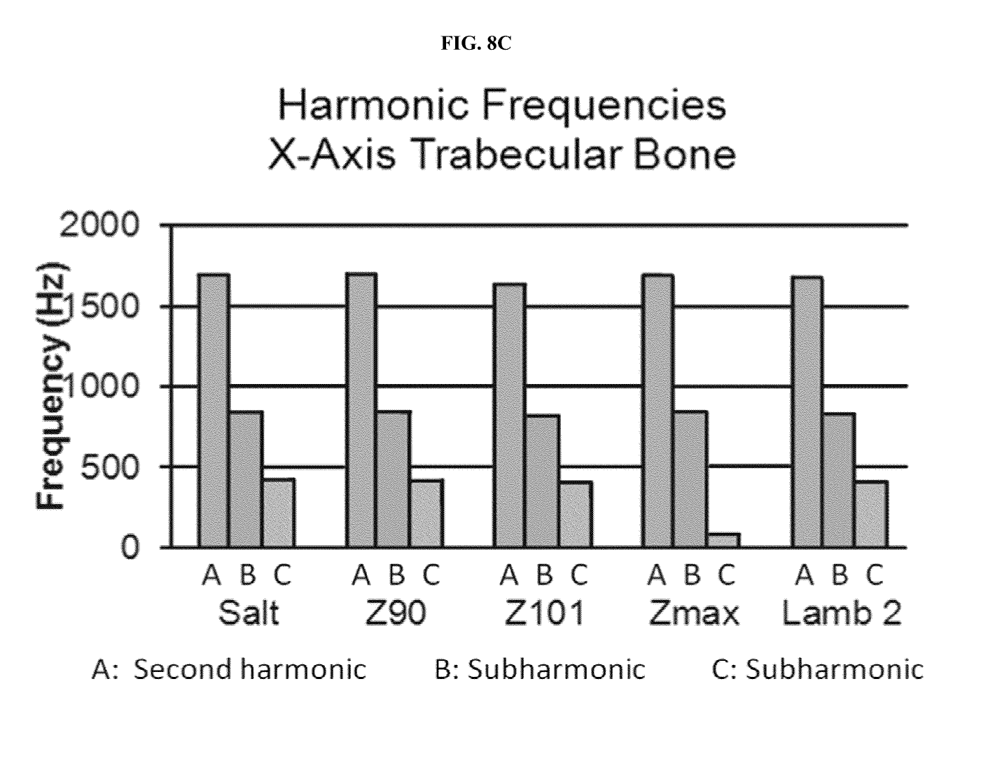

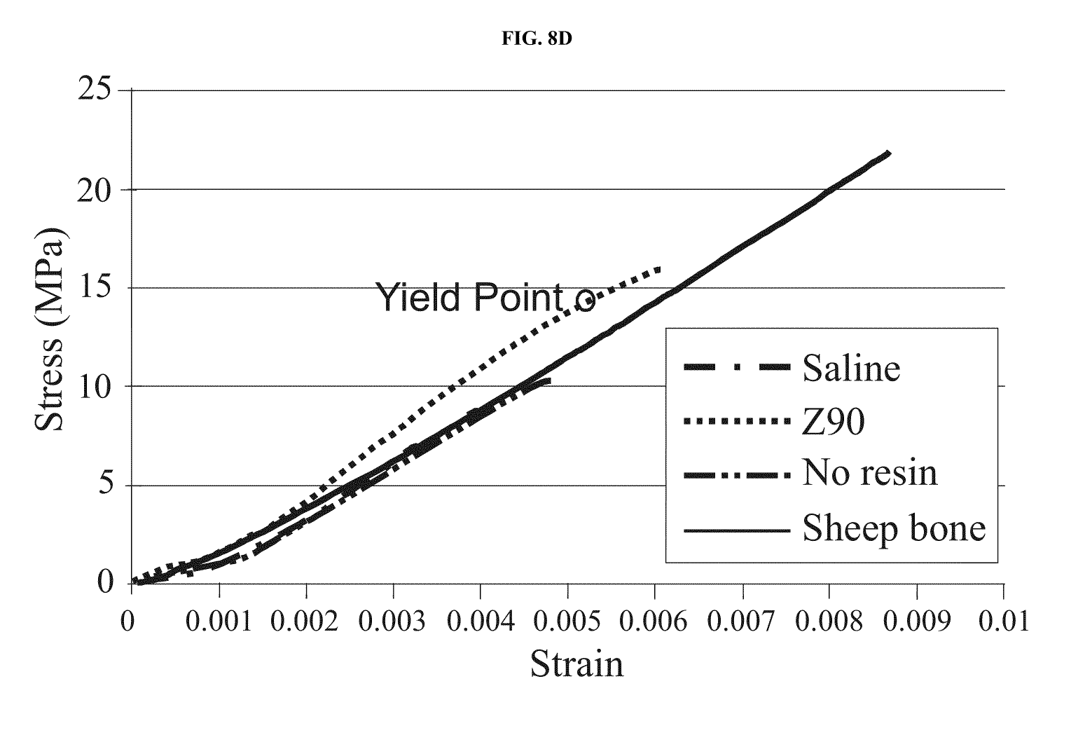

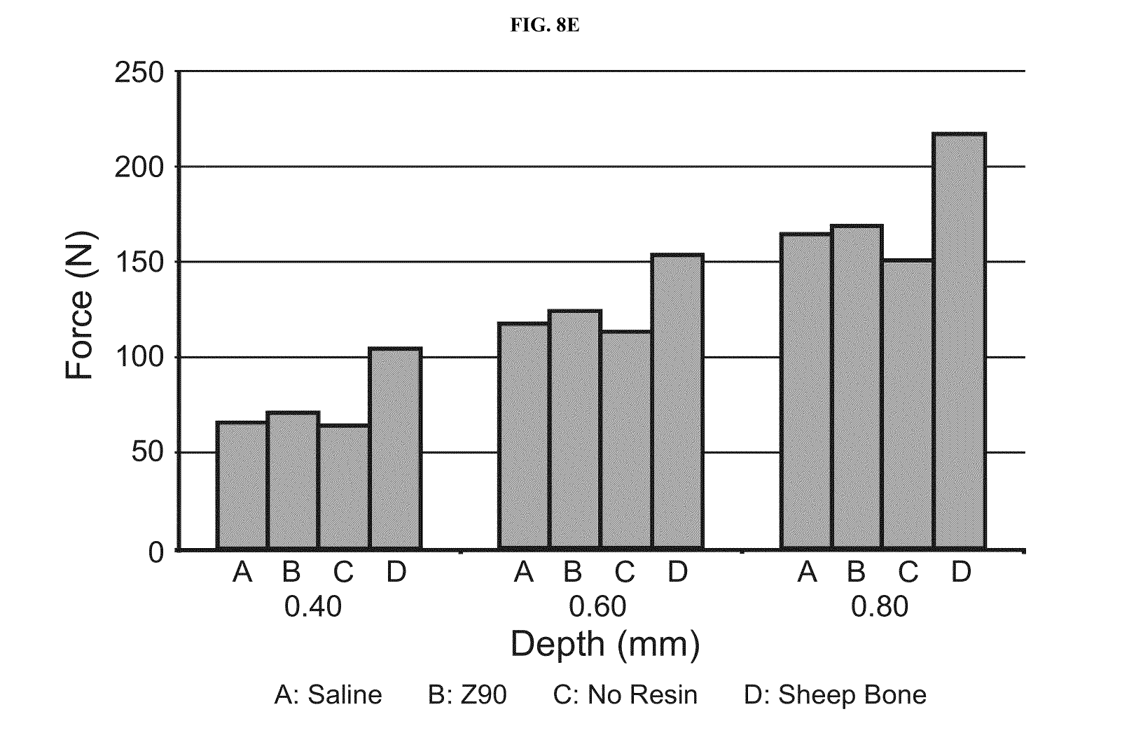

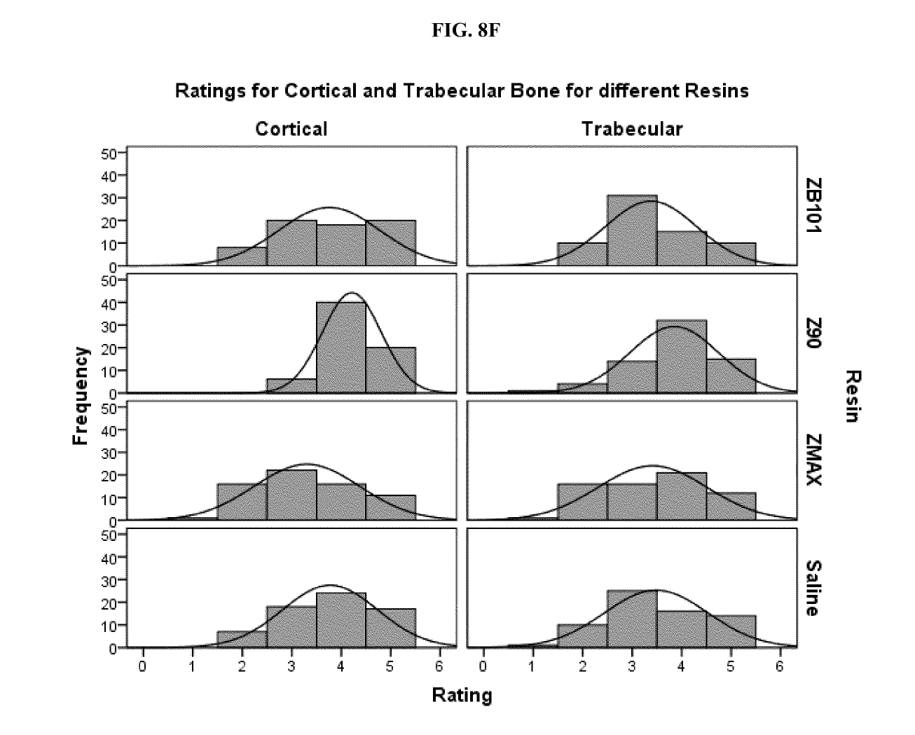

The study independently evaluated cortical and trabecular bone segments on several parameters including: hardness, vibrational properties, acoustic properties, drill skip, visual properties and overall appreciation/similarity. A likert scale was employed. The highest-ranked resin for all features both for cortical and trabecular bone was the cyanoacrylate and hydroquinone (Z90) resin. FIGS. 8A and 8C-8F show graphs and FIG. 8B shows a table of the results of a study assessing resin applied to printed objects according to embodiments of the present invention. Cyanoacrylate and hydroquinone were noted to be most bone-like in subjective and objective assessments.

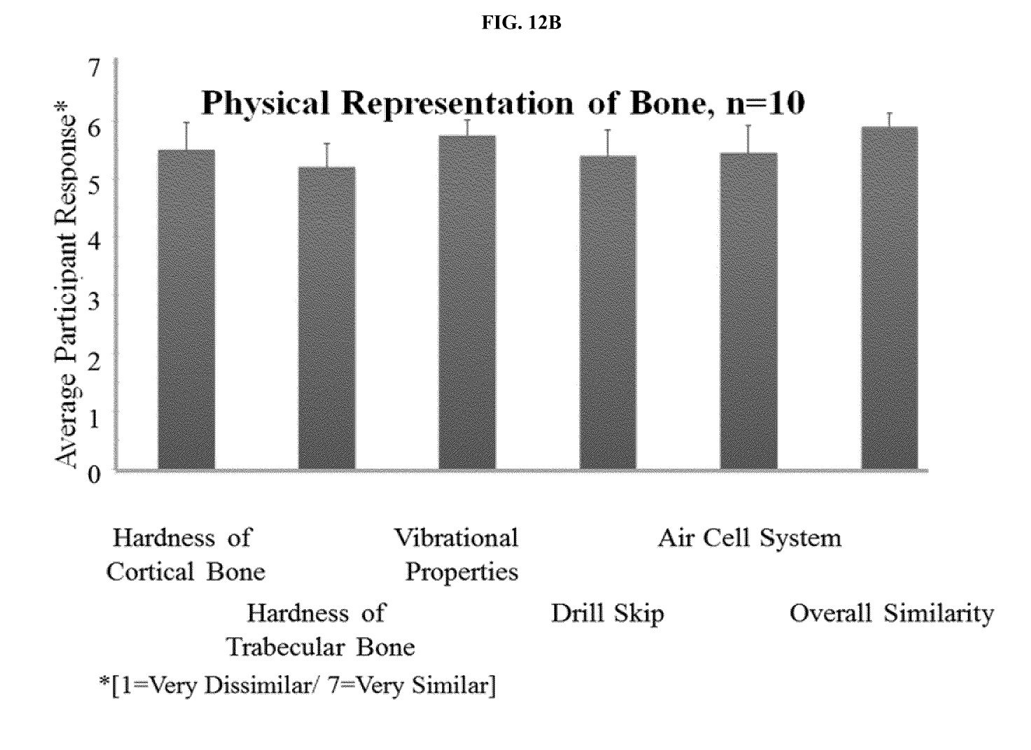

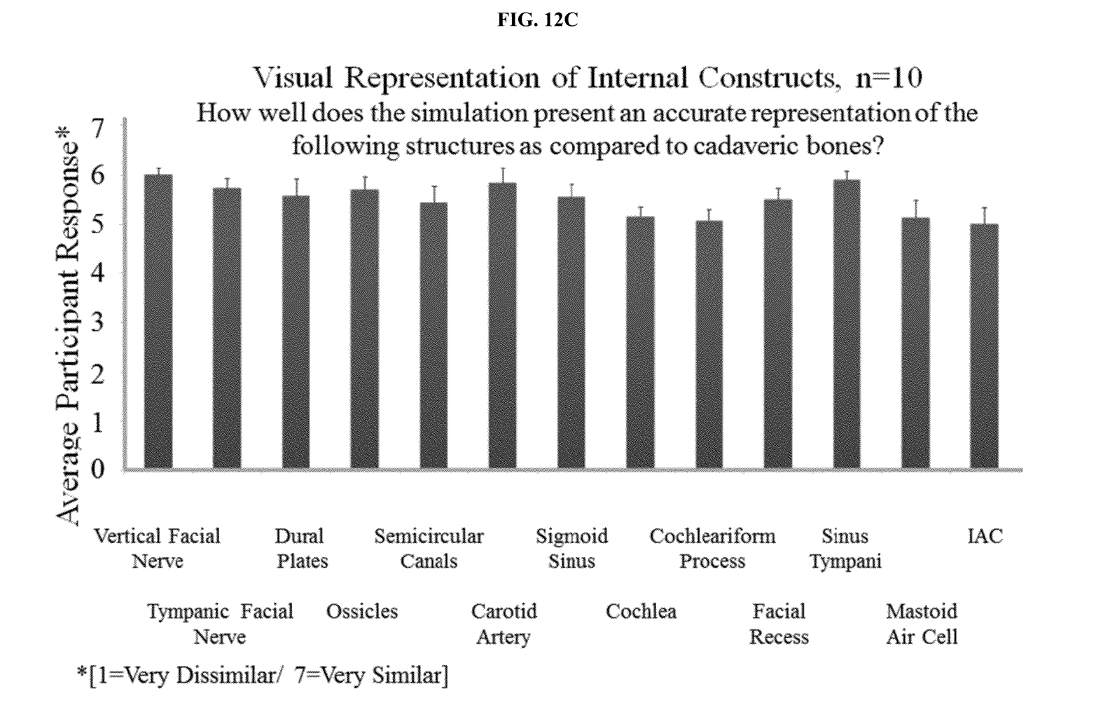

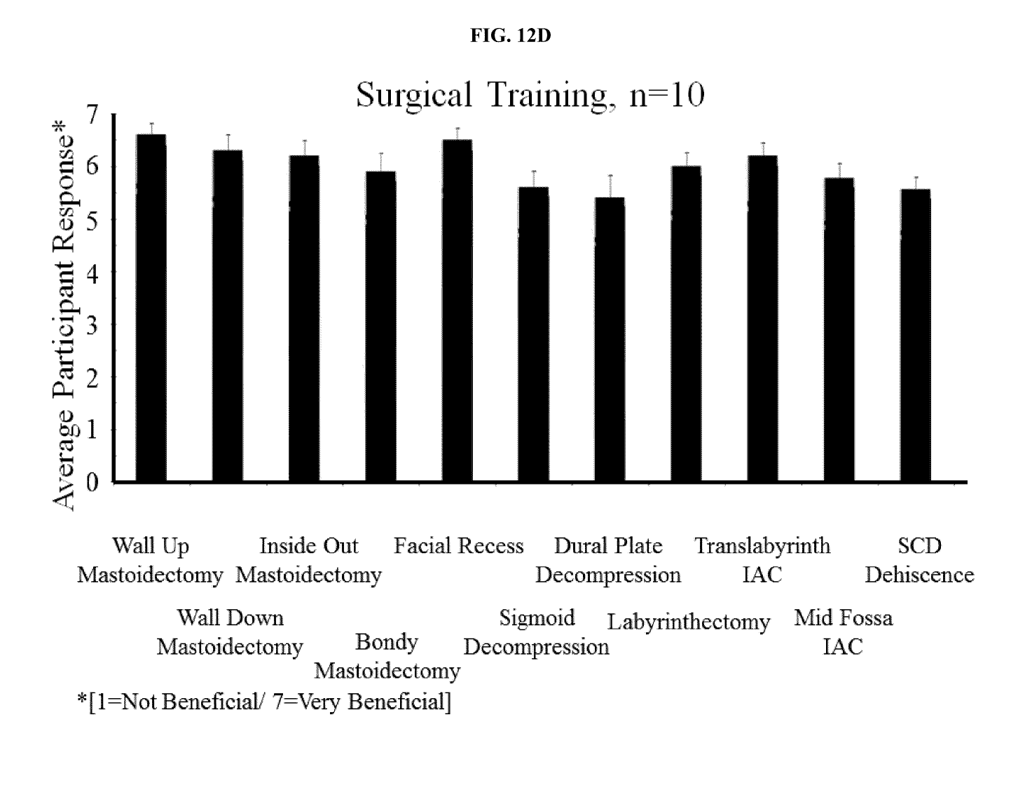

Furthermore, a validation study was conducted directly comparing a cadaveric temporal bone (gold standard) to a corresponding rapid prototype temporal bone model according to an embodiment of the present invention. FIGS. 12A-12D show the results of the validation study. In particular, FIG. 12A shows the overall appreciation evaluation, FIG. 12B shows the evaluation of the physical representation of bone, FIG. 12C shows the evaluation of visual representation of internal constructs, and FIG. 12D shows the evaluation of utility in training surgical procedures.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A method of making a three-dimensional (3D) object from a high-resolution model of a 3D object having one or more internal void spaces, the method comprising:
providing a high-resolution model of a 3D object in a computer-readable format, the 3D object having one or more internal void spaces, the model comprising a polygonal mesh including a plurality of triangles;
converting the triangles to voxels;
separating the voxels such that the model is separated into watertight pieces; and
printing the pieces using a 3D printer.

2. The method of claim 1, wherein the 3D printer is a ZPrinter™.

3. The method of claim 2, wherein the step of converting the triangles to voxels further comprises loading the plurality of triangles from the model into a spatial subdivision structure.

4. The method of claim 3, wherein the spatial subdivision structure is an octree.

5. The method of claim 3, wherein the step of converting the triangles to voxels further comprises ray tracing each piece and detecting collisions between the rays and the triangles in the spatial subdivision structure.

6. The method of claim 5, wherein the step of converting the triangles to voxels further comprises sorting the collisions from closest to furthest from ray origin.

7. The method of claim 5, wherein the step of converting the triangles to voxels further comprises filling the voxels between matching pairs of collisions with the colour of the external triangles.

8. The method of claim 1, further comprising converting the triangles to voxels for one or more secondary models.

9. The method of claim 7, further comprising converting the triangles to voxels for one or more secondary models and wherein filling the voxels for non-matching pairs of collisions with the colour of the external triangles further comprises filling a voxel with the color of the voxel of one of the secondary models.

10. The method of claim 1, further comprising assembling the pieces.

11. The method of claim 9, further comprising adding pegs and subtracting holes from the voxels of the pieces to allow for assembling the pieces of the subsequently printed 3D object.

12. The method of claim 10, wherein the method further comprises removing powder from at least one of the pieces.

13. The method of claim 10, further comprising applying an infiltrant to at least one of the pieces.

14. The method of claim 13, wherein the infiltrant is a resin.

15. The method of claim 14, wherein the resin is applied to an internal surface of the printed object prior to assembling the pieces.

16. The method of claim 15, wherein the 3D object comprises a bone.

17. A 3D object made according to the method of claim 1.

18. A 3D object made according to the method of claim 15.

19. A system comprising for making a three-dimensional (3D) object from a high-resolution model of a 3D object having one or more internal void spaces, the system comprising:
a computer network;
a computer connected to the computer network, the computer including one or more non-transient computer memories storing a high-resolution model of a 3D object in a computer-readable format, the 3D object having one or more internal void spaces, the model comprising a polygonal mesh including a plurality of triangles, and computer-readable instructions, which when executed, are for:
converting the triangles to voxels;
separating the voxels such that the model is separated into watertight pieces;
wherein the computer is configured to send computer-readable data representing the pieces over the computer network; and
a 3D printer connected to the computer network and configured to receive computer-readable data representing the pieces over the computer network and to print the pieces in physical form.

20. A computer program product for use in making a three-dimensional (3D) object from a high-resolution model of a 3D object having one or more internal void spaces, the computer program product comprising:
a tangible storage medium storing computer-readable instructions;
the computer-readable instructions including instructions for:
receiving a high-resolution model of a 3D object in a computer-readable format, the 3D object having one or more internal void spaces, the model comprising a polygonal mesh including a plurality of triangles;
converting the triangles to voxels;
separating the voxels such that the model is separated into watertight pieces; and
exporting the voxels in a format suitable for a 3D printer to print the pieces.
